(19) United States
(12) Patent Application Publication
(10) Pub. No.: US 2008/0053336 A1
(43) Pub. Date: Mar. 6, 2008

(54) Aqueous coating compositions with improved tint strength and gloss properties, comprising pigments surface-treated with certain organosilicon compounds

(75) Inventors: Daniel H. Craig, Edmond, OK (US); Jeffrey D. Elliott, Oklahoma City, OK (US); Michael E. Kidder, Piedmont, OK (US); George A. Perakis, Edmond, OK (US); Harmon E. Ray, Yukon, OK (US); Mark D. Westmeyer, Englewood, OH (US)

Correspondence Address: William B. Miller, P. O. Box 268859, Oklahoma City, OK, 73126-8859, US

(73) Assignee: Tronox LLC

(21) Appl. No.: 11/516,156

(22) Filed: Sep. 6, 2006

(51) Int. Cl. C09C 1/36; C04B 14/04

(52) U.S. Cl. 106/446; 106/490

(57) ABSTRACT

The present invention concerns aqueous coating systems, providing an aqueous coating composition which comprises water, a film-forming component and at least one inorganic pigment surface treated with one or more organosilicon compounds from the alkyltrialkoxysilanes, the dialkyldialkoxysilanes and mixtures, oligomers, and copolymers of the alkyltrialkoxysilanes and dialkyldialkoxysilanes, wherein the alkyl groups contain from three to six carbon atoms and optionally contain an oxygen atom or contain fluorine and/or chlorine heteroatoms. By controlling and limiting the amounts used of these organosilicon surface treatments, the dispersibility of a conventionally hydrophilic inorganic pigment such as titanium dioxide is not materially adversely affected, but improvements are at the same time afforded in terms of the compatibility of the pigment with the film-forming component, as demonstrated by improved tint strength and gloss properties in a paint composition.

### FIELD OF THE INVENTION

This invention relates to improved aqueous coating compositions containing inorganic pigments, and to processes for manufacturing said coating compositions. The coating compositions of this invention exhibit improved gloss and tint strength when formulated with inorganic pigments which have been surface treated with certain organosilicon compounds.

### BACKGROUND OF THE INVENTION

Inorganic pigments are used as opacifiers and colorants in many industries, including the coatings, plastics, and paper industries. In general, the effectiveness of the pigment in such applications depends on how evenly the pigment can be dispersed in a coating, in plastic or in paper. For this reason, inorganic pigments are generally handled in the form of a finely divided powder. For example, titanium dioxide, the most widely used white pigment in commerce today due to its ability to confer high opacity when formulated into end-use products, is conventionally handled in the form of a finely divided powder. However, titanium dioxide powders are inherently dusty and frequently exhibit poor powder flow characteristics, especially during formulation, compounding, and manufacture of end-use products. While free-flowing powders with low dust properties can be obtained through known manufacturing practices, these powders usually exhibit reduced opacifying properties. To this end, chemical modification of titanium dioxide pigment surfaces has developed into the preferred approach to achieving the desired balance of pigment opacity and flow characteristics.

It is known in the art that the wetting and dispersing properties of titanium dioxide pigments, particularly when used in coatings, can be improved by exposure to certain inorganic treatments, for example, depositing inorganic metal oxide and/or metal hydroxide coatings on the surface of the titanium dioxide. In addition, certain other chemical modifications of titanium dioxide pigment surfaces, involving treatment with organic compounds such as certain organic polyols, are also known to improve pigment performance, including helping to reduce the tendency of a pigment to adsorb moisture and helping to improve its gloss characteristics in coatings.

It is also known to treat oxide pigment surfaces with other types of organics, for example, various organosilicon compounds, for use especially in plastics. Such treatments can improve the reinforcing properties of the pigment in such environments, as well as providing improved thermoplastics processing and uniformity of color together with still other benefits. Many patents have been issued in view of these various benefits, disclosing methods for improving titanium dioxide pigments wherein an organosilicon compound is deposited onto the pigment surface prior to its incorporation into such end use materials as, particularly, thermoplastics and thermosetting resins, but also to a lesser extent in coatings, inks and in paper. For example:

U.S. Pat. No. 3,132,961 discloses a process for rendering finely divided non-alkaline filler material hydrophobic by contacting said finely divided filler material with a diorganopolysiloxane in the presence of an acid. Among the filler materials described are silica, clay, iron oxides, and titanium dioxide.

U.S. Pat. No. 3,227,675 describes the surface treatment of kaolin clay with up to 10% by weight based on clay of an organofunctional silane for the purpose of providing improved clay-reinforcing properties to thermosetting resins.

U.S. Pat. No. 3,567,680 discloses use of mercaptosilane grafted inorganic pigments in combination with aminosilane treated pigment, to achieve higher filler reinforcement of elastomers and plastics.

U.S. Pat. No. 3,834,924 discloses an improved process for producing surface modified, finely divided inorganic pigments comprising the addition of an amino organosilane to a high solids content aqueous dispersion of said inorganic pigment, with subsequent extrusion and drying. These pigments are useful as fillers for paper, paints, inks, and as reinforcing pigments in elastomers and polymeric materials.

U.S. Pat. No. 4,061,503 discloses the treatment of particulate titanium dioxide with a polyether substituted silicon compound which serves to enhance its employment in pigmented and/or filled paints and plastics, and in reinforced plastic composite compositions.

U.S. Pat. No. 4,141,751 discloses a process for the modification of hydrophilic particulate and/or fibrous crystalline and/or amorphous inorganic substances with silane coupling agents to produce materials which are eminently suitable for use as reinforcing filler/extender pigments in polymeric, polymeric alloy, and polymeric/ceramic alloy compositions.

U.S. Pat. No. 4,151,154 discloses compositions comprising inorganic particles containing on their surfaces a silane, its hydrolyzates or resulting condensates, which silane possesses at least two to about three hydrolyzable groups bonded to the silicon thereof and an organic group which contains a polyalkylene oxide group. These modified inorganic particles exhibit enhanced performance in pigmented and/or filled paints and plastics, and in reinforcing plastic composite structures.

U.S. Pat. No. 4,344,799 is directed toward titanium dioxide pigments with a coating of hydrophobicizing and hydrophilicizing organic substances, wherein the hydrophobicizing organic substance is an organic silicon compound and/or an organic phosphorus compound and the hydrophilicizing organic compound is an amino alcohol. These pigments are readily dispersible which simplifies their use in pigmenting laquers, plastics, and paper.

U.S. Pat. No. 4,375,989 discloses improved dispersibility of a titanium dioxide pigment by coating the pigment with an organic coating selected from the group comprising large-molecule fatty acids and their salts; organic silicon compounds, such as dimethyl polysiloxane; alcohols and polyalcohols. The titanium dioxide pigment also comprises a coating of an inorganic substance.

U.S. Pat. No. 4,514,231 is directed to the modification of natural oxidic or silicate fillers with water insoluble sulfur containing organosilicon compounds. The fillers are converted into an aqueous suspension and treated with the organosilicon compounds, in some cases in the presence of an emulsifier to improve reaction between the filler and the organosilicon compound. The compositions are particularly suitable for use in vulcanizable and moldable mixtures which are produced according to customary processes in the rubber industry.

U.S. Pat. No. 4,810,305 describes a modified hydrophobic colored or magnetic pigment or filler comprising a hydrophobic pigment or filler containing a surface treatment derived from an organopolyhydrosiloxane. Compositions include titanium dioxide pigments and are useful as pigments or fillers in synthetic resins.

U.S. Pat. No. 4,801,445 and U.S. Pat. No. 4,882,225 are directed toward cosmetics compositions containing modified powders or particulate materials having a silicone polymer film coated on substantially the entire surface, said silicone polymer being derived from at least one silicone compound containing an Si—H group.

U.S. Pat. No. 4,935,063 discloses inorganic fillers or pigments having simultaneous reinforcing effect and stabilizing effect on organic polymers obtained by a process comprising bringing the inorganic filler or pigment into contact with a solution, in an inert organic solvent, of a sterically hindered amine comprising one or more alkoxysilane groups in its molecule, maintaining the obtained mixture at higher than ambient temperature for a period of at least 0.5 hours, removing the solvent, and recovering the stabilizing filler or pigment obtained.

U.S. Pat. No. 5,035,748 describes an inorganic pigment comprising a content of at least 0.1% by weight and at most 5% by weight of one or more polyorganosiloxanes, wherein the polyorganosiloxanes have viscosities of 10 to 100,000 mPa·s and a relative molecular weight of 500 to 500,000, have no reactive or crosslinking groups, contain at least one C₉-C₂₅ Si-alkyl and/or one C₉-C₂₅ Si-aryl group per molecule, the total content of these groups in the polyorganosiloxane being 7-70% by weight and the other organic radicals contained in the polyorganosiloxane having 1 to 8 carbon atoms. These pigments can be used in laquers, emulsion paints, plastics, toners, magnetic recording materials, building materials, and enamels.

U.S. Pat. No. 5,501,732 discloses an improved process for preparing silanized titanium dioxide pigment for plastic and coating applications using a titanium dioxide slurry as a feedstock, wherein the viscosity of the high solids titanium dioxide slurry is reduced by adjusting the pH of the slurry in the range of about 7.5 to about 11.

U.S. Pat. No. 5,562,990 discloses organosilicon treatment of titanium dioxide particles coated with alumina or alumina-silica having a fluoride compound or fluoride ions associated with them to improve photostability and humidity resistance when incorporated in powder coatings and/or plastics.

U.S. Pat. No. 5,607,994, U.S. Pat. No. 5,631,310, U.S. Pat. No. 5,889,090, and U.S. Pat. No. 5,959,004 claim processes and compositions relating to white-pigmented polymers (particularly, polyolefins such as polyethylene) containing white pigments treated with at least one silane or a mixture of at least one silane and at least one polysiloxane resulting in improved processibility in thermoplastics compounding and improved performance properties, such as lacing resistance, in a polymeric matrix. Preferred silanes compounds are alkyl trialkoxysilanes.

U.S. Pat. No. 5,653,794 and U.S. Pat. No. 6,214,106 B1 disclose processes for the manufacture of hydrophobic inorganic oxides which comprise reacting inorganic oxide particles with organohalosilanes, preferably organochlorosilanes, to produce hydrophobic organosilane coated inorganic oxides, and compositions resulting from said processes. The inorganic oxide pigments prepared by these processes exhibit enhanced compatibility and adhesion between the pigment and organic matrices, such as thermoplastics. It is preferred that the organohalosilane compounds be reacted with the inorganic oxide particles in an aqueous slurry.

Great Britain Patent 825,404 is referenced by the just-mentioned U.S. Pat. No. 6,214,106, and is of interest also for disclosing organosilane treatments of titanium dioxide to improve dispersibility in organic solvents used for making paints, preferred organosilanes including alkyltrialkoxysilanes, such as methyltriethoxysilane and ethyltriethoxysilane, as well as dialkyldialkoxysilanes, such as dimethyl diethoxysilane.

U.S. Pat. No. 5,707,437 describes titanium dioxide pigment particles with treatment of an organosilicon compound and boric acid and/or boron oxide. The resulting compositions, when incorporated into a polymer, exhibits humidity resistance, enhanced dispersion, and resistance to yellowing or discoloration of the pigmented polymer upon exposure to ultraviolet light. The resulting compositions are particularly useful in powder coatings and/or plastics applications.

U.S. Pat. No. 6,126,915 describes titanium dioxide powder with a greatly decreased volatile moisture content obtained by surface treating with a calcium salt and/or a silane coupling agent. Thermoplastic masterbatches containing this titanium dioxide powder do not exhibit defects due to foam generation resulting from high temperature processing.

U.S. Pat. No. 6,133,360 discloses thermoplastic resin compositions containing an aromatic polycarbonate resin and a surface modified titanium dioxide having a first coating and no further coatings. Preferred titanium dioxide first coating materials are polyols or polysiloxanes. The thermoplastic resin compositions exhibit improved resistance to streaking compared to such thermoplastic resin compositions which incorporate titanium dioxide having a first coating and at least one additional coating.

U.S. Pat. No. 6,395,858 discloses aminopropyl-functional siloxane oligomers, to the processes for preparing said oligomers, and to their use as reinforcing agents, surface modifying agents, or in coatings.

U.S. Pat. No. 6,455,158 B1 relates to the silanization or surface treatment of minerals with alkylsilanes and alkylsilane copolymers and to alkylsilane copolymers useful for surface treating pigments or fillers. The alkylsilane copolymers comprise at least two different monomers and find utility for the surface treatment of white pigments, such as titanium dioxide, for improving the dispersibility and processibility of the pigments when compounded with a polymeric material such as polyolefins.

U.S. Pat. No. 6,573,018 B2 describes surface-treated metallic oxide fine powders comprising a silane coupling agent containing primary amino groups useful in powder coatings or electrophotographic toners.

U.S. Pat. No. 6,576,052 B1 discloses titanium dioxide particles comprising a coating layer of an aluminum phosphate compound and a coating layer of the hydrolyzate of an organosilane compound, said pigment exhibiting improved light fastness, lacing resistance, and dispersibility in plastics.

U.S. Pat. No. 6,616,746 B2 describes a titanium dioxide pigment having on the surface a coating layer comprising a polyhydric alcohol and a hydrolysis product of an aminosilane compound. The pigment is useful as a coloring agent for plastics.

U.S. Pat. No. 6,620,234 B1 provides a treatment method for rendering titanium dioxide pigment hydrophobic by predispersing a suitably reactive organohalosilane into an aqueous media, using intensive mixing means to form a reactive dispersion, followed by exposing titanium dioxide particles to said reactive dispersion. The resulting pigments have good dispersibility in nonpolar substances such as plastics.

U.S. Pat. No. 6,663,851 B1 discloses a product obtained by treating surface-modified, pyrogenically produced titanium dioxide with at least one ammonium-functional silane, useful in the field of cosmetics in sunblocks, in toner powders, in paints and varnishes, in silicone rubber, and as abrasives and polishes.

U.S. Patent Application Publication No. US 2002/0172697 A1 describes a metal oxide-organopolysiloxane hybrid powder, a method for the preparation thereof, and a cosmetic composition containing said powder.

U.S. Patent Application Publication No. US 2003/0027896 A1 discloses a surface modified inorganic oxide powder having a surface modified with a mixed solution, which includes an organopolysiloxane and a silane compound. The resulting powders improve reinforcement of polar resins.

U.S. Patent Application Publication No. US 2003/0079655 A1 discloses a titanium dioxide pigment having a surface coating layer comprising a polyhydric alcohol and a hydrolysis product of an aminosilane compound, has a dispersibility of not more than 20 kg/cm as judged in terms of resin pressure increase, and is excellent in hydrophobicity and dispersibility. The pigment is useful as a coloring agent for plastics.

U.S. Pat. No. 6,770,327 discloses aminoalkylalkoxy silane mixtures comprising optionally, alkyl or hydroxyalkyl-functionalized siloxanes, to processes for preparing said mixtures, and to their use as reinforcing agents, surface modifying agents, or in coatings.

U.S. Pat. No. 6,841,197 discloses oligomer mixtures of n-propylethoxy silanes, to processes for preparing said mixtures, and to their use as reinforcing agents, surface modifying agents, or in coatings.

DE 197 51 857 A1 describes a method for producing phosphonatosiloxane-treated inorganic particles by incorporating organophosphonate compounds into organosiloxane compounds, such compounds being useful in plastics applications.

European Patent Specification EP 1 065 234 B1 relates to novel silicones for powder treatment, powders having the surface treated with such silicones, and cosmetic materials containing such surface-treated powders, wherein the surface treatment imparts to the powder a high affinity for fats and oils, including ester oils, glycerides, silicone oils, and fluorinated oils.

European Patent Specification EP 1 245 646 B1 describes titanium dioxide pigments having excellent light fastness and hydrophobic characteristics wherein the titanium dioxide is coated with an aluminum phosphate compound followed by a surface treatment with a hydrolyzate of an organosilane compound yielding a pigment particularly suited for use in plastics.

European Patent Specification EP 1 424 373 A2 relates to hydrophilized powders wherein the powder surface is treated with a polyether-modified silicone, and to their application in cosmetics, coatings, and inks.

U.S. Patent Application Publication No. US 2005/0129602 A1 discloses a process for production of titanium dioxide pigment and resin compositions comprising coating the hydrolysis product of an alkylsilane compound containing at least one C₆H₁₃ group by dry processing on surfaces of particles of titanium dioxide.

From the patents cited above it is clear that many uses of organosilicon compound-treated pigments have been documented. However, despite the large number of disclosures relating to organosilicon compound treatments, it is surprising that a relatively small proportion of them pertain to improved coatings compositions. For pigmented coatings, improved pigment dispersion properties resulting from surface treatment techniques are known to result in improved coating properties, including higher gloss, higher opacity, and improved tint strength. Some of the many factors influencing water-borne paint performance, in particular gloss and the compatibility of pigments such as titanium dioxide with latex binders, in aqueous coating systems are discussed in U.S. Patent Application Publication US 2003/0022970 A1, now U.S. Pat. No. 6,638,998, which is incorporated herein by reference.

### SUMMARY OF THE PRESENT INVENTION

The present invention concerns aqueous coating systems, and in a first aspect provides an aqueous coating composition which comprises water, a film-forming component and at least one inorganic pigment surface treated with one or more organosilicon compounds from the alkyltrialkoxysilanes, the dialkyldialkoxysilanes and mixtures, oligomers, and copolymers of the alkyltrialkoxysilanes and dialkyldialkoxysilanes, wherein the alkyl groups contain from three to six carbon atoms and optionally contain an oxygen atom or contain fluorine and/or chlorine heteroatoms. Conventionally such alkyl groups impart hydrophobic characteristics, but by controlling and limiting the amounts used of these organosilicon surface treatments in an aqueous coating composition according to the present invention, the dispersibility in the composition of a conventionally hydrophilic inorganic pigment such as titanium dioxide is not materially adversely affected, but improvements are at the same time afforded in terms of the compatibility of the pigment with the film-forming component, typically being a water-soluble or water-dispersible, polymeric binder material, as demonstrated by improved tint strength and gloss properties.

### DETAILED DESCRIPTION OF PREFERRED EMBODIMENTS OF THE PRESENT INVENTION

The aqueous coating compositions contemplated by the instant invention include at least water, a film-forming component and at least one inorganic pigment. The film-forming component is typically a water-dispersible or water-soluble polymeric binder material, many such materials having been known and used in previous pigmented aqueous coating compositions. Any other components known or commonly-used in pigmented aqueous coating compositions, for example, rheology modifiers, biocides, wetting agents, dispersants, coalescing agents and other fillers, may also be present in the aqueous coating compositions of the present invention.

Preferably the aqueous coating compositions will utilize as an inorganic pigment titanium dioxide which has been surface treated with one or more organosilicon compounds from the alkyltrialkoxysilanes, the dialkyldialkoxysilanes and mixtures, oligomers, and copolymers of the alkyltrialkoxysilanes and dialkyldialkoxysilanes, wherein the alkyl groups of these materials contain from three to six carbon atoms and optionally contain an oxygen atom or contain fluorine and/or chlorine heteroatoms. Preferred organosilicon compounds are the alkyltrialkoxysilanes, the dialkyldialkoxysilanes and mixtures, oligomers, and copolymers of the alkyltrialkoxysilanes and dialkyldialkoxysilanes, wherein the alkyl groups contain three carbon atoms.

Surprisingly, only a very narrow range of carbon atoms in the alkyl group is useful for the instant invention. In this regard, for the usually preferred circumstance wherein the only organic surface treatments of the inorganic pigment are accomplished by means of the above-described organosilicon materials, experimental results demonstrate that when the number of carbon atoms in the alkyltrialkoxysilane or dialkyltrialkoxysilane alkyl groups is greater than six, the pigments become too difficult to disperse in water-borne coatings, and when the alkyl groups contain only one or two carbon atoms there is no beneficial effect observed in the performance of the coating. Those skilled in the art will appreciate, however, that other organic surface treatment materials known in the art may be used with the organosilicon surface treatment materials of the present invention, if desired for providing improvements in performance or imparting certain properties to the pigments.

The amount of organosilicon material added as a surface treatment according to the instant invention will be an amount sufficient to provide a treated inorganic particulate-containing coating composition with improved performance properties over that of a coating composition derived from the corresponding untreated inorganic particulate. Preferably the organosilicon material is incorporated on the inorganic particulate, again preferably being titanium dioxide, in an amount ranging from about 0.1 to about 5 weight percent in total, based on the weight of the inorganic particulate. More preferred is an organosilicon material content ranging from about 0.25 percent to about 2.5 percent, based on the weight of the inorganic particulate. Most preferably, the surface treated inorganic particulate will use from about 0.5 percent to about 1.5 percent of these materials, based on the weight of the inorganic particulate.

The pigment surface treatments can be accomplished using any of the known methods of treating pigment surfaces, such as deposition in a fluid energy mill, applying the organosilicon material to the dry pigment by mixing or spraying, or through the drying of pigment slurries containing the organosilicon material.

Inorganic pigments, which can also be referred to as fillers, extenders or reinforcing pigments, improved by the instant invention include any of the particulate inorganic pigments known in the surface coatings and plastics industries. Examples include white opacifying pigments such as titanium dioxide, basic carbonate white lead, basic sulfate white lead, basic silicate white lead, zinc sulfide, zinc oxide; composite pigments of zinc sulfide and barium sulfate, antimony oxide and the like; white extender pigments such as calcium carbonate, calcium sulfate, china and kaolin clays, mica, diatomaceous earth; and colored pigments such as iron oxide, lead oxide, cadmium sulfide, cadmium selenide, lead chromate, zinc chromate, nickel titanate and chromium oxide. Titanium dioxide, of either the anatase or rutile crystalline structure or some combination thereof, is again most preferred among the inorganic pigments. The titanium dioxide pigment can have deposited thereon any of the inorganic metal oxide and/or metal hydroxide surface coatings known to the art, prior to treatment with the organosilicon compound according to the instant invention.

Other components of the aqueous coating systems of the present invention can (as mentioned previously) be any previously known to the art, with substituting the organosilicon compound surface-treated inorganic oxide pigments contemplated by the present invention for the inorganic oxide pigments previously known and used in any such aqueous coating systems. Various conventional components are evident from the examples below, but those skilled in the art will recognize that very many different combinations of materials and very many different aqueous coating compositions are known in which the organosilicon compound surface-treated inorganic oxide pigments of the present invention can be used with success. Recent United States Patents pertaining to aqueous coating systems include, for example, U.S. Pat. Nos. 6,969,734, 6,869,996, 6,762,230 and 6,646,058. While undoubtedly such other components will in any commercial sense be required for the aqueous coating compositions of the present invention, in addition to the water, film-forming component and organosilicon compound surface-treated inorganic pigment components, these other components are in any event well-known and need not be described further herein.

The following examples serve to illustrate specific embodiments of the instant invention without intending to impose any limitations or restrictions thereto. Concentrations and percentages are by weight unless otherwise indicated.

### ILLUSTRATIVE EXAMPLES

### Example 1

Particulate titanium dioxide pigment intermediate obtained from the vapor phase oxidation of titanium tetrachloride containing 1.0% alumina was dispersed in water in the presence of 0.15% by weight (based on pigment) of sodium hexametaphosphate dispersant, along with a sufficient amount of sodium hydroxide to adjust the pH of the dispersion to 9.5 and greater, to achieve an aqueous dispersion with a solids content of 35% by weight. The resulting titanium dioxide slurry was sand milled, using a zircon sand-to-pigment weight ratio of 4 to 1, until a volume average particle size was achieved wherein more than 90% of the particles were smaller than 0.63 microns, as determined utilizing a Microtrac X100 Particle Size Analyzer (Microtrac Inc. Montgomeryville, Pa.).

The resulting slurry, diluted to 30% solids by weight, was heated to 90° C. then treated with 3.0%, calculated as silica by weight of final pigment, of sodium silicate, added over 20 minutes as a 250 gram/liter aqueous sodium silicate solution (SiO₂:Na₂O=3.5). While maintaining the temperature at 90° C., the pH of the slurry was slowly decreased to pH=5.0 using 25% by weight aqueous sulfuric acid solution, over a 55 minute period. Following a digestion period of 15 minutes, 2.0% alumina, by weight of final pigment, was added over 15 minutes as a 357 gram/liter aqueous sodium aluminate solution while maintaining the pH of the slurry between a value of 8.0 and 8.5 via the concomitant addition of 25% aqueous sulfuric acid.

The dispersion was allowed to equilibrate at 90° C. for 15 minutes, at which point the pH of the slurry was re-adjusted to 5.8, prior to filtration while hot. The resulting filtrate was washed with an amount of water, which had been preheated to 60° C. and pre-adjusted to a pH of 7.0, equal to the weight of recovered pigment.

The washed semi-solid filtrate was subsequently re-dispersed in water with agitation in the presence of 0.50%, by weight based on pigment, of hexyltrimethoxysilane. The resulting pigment dispersion was spray dried using an APV Nordic PSD52 Spray Dryer (Invensys APV Silkeborg, Denmark), maintaining a dryer inlet temperature of approximately 280° C., to yield a dry pigment powder. The dry pigment powder was then steam micronized in the presence of 0.35% by weight based on pigment of trimethylol propane, utilizing a steam to pigment weight ratio of 2.5, with a steam injector pressure set at 146 psi and micronizer ring pressure set at 118 psi, completing the finished pigment preparation.

As a comparative example, the same procedure described above was repeated, but in the absence of the addition of the hexyltrimethoxysilane. The resulting pigment produced according to the inventive process and the comparative pigment were both evaluated for paint film gloss and tint strength performance in a water-borne coating, according to the recipe and test procedures presented below. Results are provided in Table 1.

### Paint Formulation and Procedure:

| Ingredients | Parts by Weight |
|---|---|
| Propylene Glycol | 11.9 |
| Tamol ® 731 | 2.4 |
| Igepal ® CO-630 | 1.3 |
| Foammaster ® SA-3 | 0.24 |
| Water | 10.2 |
| Titanium dioxide pigment | 59.8 |

Tamol ® 731 = diisobutylene/maleic acid alternating copolymer disodium salt 25% in water; Rohm and Haas Company
Igepal ® CO-630 = nonylphenoxy poly(ethyleneoxy)₉ ethanol; Rhodia Inc.
Foammaster ® SA-3 = oil-based defoamer; Cognis Corporation

The above components were added in the sequence indicated and mixed at high shear for twenty minutes, after which the components listed below were added in sequence with continued, but lower shear, mixing until homogeneous, to yield a 22% PVC (percent pigment volume concentration), 36% NVV (percent non-volatiles by volume), water-borne coating with final pH=8.8 and final viscosity=five poise.

| Ingredients | Parts by Weight |
|---|---|
| Rhoplex ® AC-2508 | 122.5 |
| Foammaster ® SA-3 | 0.20 |
| Ammonium Hydroxide (25%) | 0.20 |
| Water | 11.2 |
| Texanol ® | 5.6 |
| Natrosol ® 250 MR (added as a 2.5% solution | 10.2 |
| containing 1% Proxel ® GXL preservative) | |
| Lamp black | 1.6 |

Texanol ® ester alcohol = 2,2,4-trimethyl-1,3-pentanediol mono (2-methylpropanoate); Eastman Chemicals Company
Rhoplex ® AC-2508 = aqueous poly(butylacrylate-co-methylmethacrylate) latex dispersion; Rohm and Haas Company
Natrosol ® 250 MR = hydroxyethyl cellulose; Hercules Incorporated Aqualon Division
Lamp black = Colortrend ® B-Lamp Black; dispersion in mixed glycol solvent; Tenneco Chemicals, Inc.
Proxel ® GXL = 1,2-benzoisothiazoline-3-one; Avecia Inc.

### Gloss: gloss measurements were performed according to ASTM method D-523-89.

### Tint Strength: tint strength measurements were performed according to ASTM method D-2745-00.

TABLE 1
Paint Film Properties of Organosilicon Compound-Treated
TiO₂-Containing Water-Borne Paints

| Pigment Sample | Gloss (60°) | Tint Strength |
|---|---|---|
| Example 1 | 65 | 106 |
| Comp. Ex. 1 | 61 | 105 |

The aqueous coating composition produced according to the instant invention, comprising a titanium dioxide pigment having deposited thereon an inorganic oxide surface treatment of 3.0% silica and 2.0% alumina, both by weight of the pigment, and an organic surface treatment comprising 0.50% by weight of pigment of hexyltrimethoxysilane according to the present invention, thus demonstrates improved properties as indicated by the increased gloss and tint strength values for the inventive coating composition versus the comparative example.

### Example 2

Particulate titanium dioxide pigment intermediate obtained from the vapor phase oxidation of titanium tetrachloride containing 1.0% alumina was dispersed in water in the presence of 0.15% by weight (based on pigment) of sodium hexametaphosphate dispersant, along with a sufficient amount of sodium hydroxide to adjust the pH of the dispersion to a value of 9.5 and greater, to achieve an aqueous dispersion with a solids content of 35% by weight. The resulting titanium dioxide slurry was sand milled, using a zircon sand-to-pigment weight ratio of 4 to 1, until a volume average particle size was achieved wherein more than 90% of the particles were smaller than 0.63 microns, as determined utilizing a Microtrac X100 Particle Size Analyzer.

The resulting slurry, diluted to 30% solids by weight, was heated to 90° C. then treated with 3.0%, calculated as silica by weight of final pigment, of sodium silicate, added over 20 minutes as a 250 gram/liter aqueous sodium silicate solution (SiO₂:Na₂O=3.5). While maintaining the temperature at 90° C., the pH of the slurry was slowly decreased to pH=5.0 using 25% by weight aqueous sulfuric acid solution, over a 55 minute period. Following a digestion period of 15 minutes, 2.0% alumina, by weight of final pigment, was added over 15 minutes as a 357 gram/liter aqueous sodium aluminate solution while maintaining the pH of the slurry between a value of 8.0 and 8.5 via the concomitant addition of 25% aqueous sulfuric acid.

The dispersion was allowed to equilibrate at 90° C. for 15 minutes, at which point the pH of the slurry was re-adjusted to 5.8, prior to filtration while hot. The resulting filtrate was washed with an amount of water, which had been preheated to 60° C. and pre-adjusted to a pH of 7.0, equal to the weight of recovered pigment. The washed semi-solid filtrate was subsequently re-dispersed in water with agitation in the presence of 1.0%, by weight based on pigment, of propyltrimethoxysilane according to the present invention. The resulting pigment dispersion was spray dried using an APV Nordic PSD52 Spray Dryer, maintaining a dryer inlet temperature of approximately 280° C., to yield a dry pigment powder. The dry pigment powder was then steam micronized in the presence of 0.35% by weight based on pigment of trimethylol propane, utilizing a steam to pigment weight ratio of 2.5, with a steam injector pressure set at 146 psi and micronizer ring pressure set at 118 psi, completing the finished pigment preparation.

As a comparative example, the same procedure described above was repeated, but in the absence of the addition of the propyltrimethoxysilane. The resulting pigment produced according to the inventive process and the comparative pigment were both evaluated for paint film gloss and tint strength performance in a water-borne coating, according to the recipe and test procedures described in Example 1. Results are provided in Table 2.

TABLE 2
Paint Film Properties of Organosilicon Compound-Treated
TiO₂-Containing Water-Borne Paints

| Pigment Sample | Gloss (60°) | Tint Strength |
|---|---|---|
| Example 2 | 66 | 110 |
| Comp. Ex. 2 | 62 | 107 |

The coating composition produced according to the instant invention, comprising a titanium dioxide pigment having deposited thereon an inorganic oxide surface treatment of 3.0% silica and 2.0% alumina, both by weight of the pigment, and an organic surface treatment comprising 1.0% by weight of pigment of propyltrimethoxysilane, further demonstrates improved properties as indicated by the increased gloss and tint strength values for the inventive coating composition versus the comparative example.

### Example 3

Particulate titanium dioxide pigment intermediate obtained from the vapor phase oxidation of titanium tetrachloride containing 1.0% alumina was dispersed in water in the presence of 0.15% by weight (based on pigment) of sodium hexametaphosphate dispersant, along with a sufficient amount of sodium hydroxide to adjust the pH of the dispersion to a value of 9.5 and greater, to achieve an aqueous dispersion with a solids content of 35% by weight. The resulting titanium dioxide slurry was sand milled, using a zircon sand-to-pigment weight ratio of 4 to 1, until a volume average particle size was achieved wherein more than 90% of the particles were smaller than 0.63 microns, as determined utilizing a Microtrac X100 Particle Size Analyzer.

The resulting slurry, diluted to 30% solids by weight, was heated to 90° C. then treated with 3.0%, calculated as silica by weight of final pigment, of sodium silicate, added over 20 minutes as a 250 gram/liter aqueous sodium silicate solution (SiO₂:Na₂O=3.5). While maintaining the temperature at 90° C., the pH of the slurry was slowly decreased to pH=5.0 using 25% by weight aqueous sulfuric acid solution, over a 55 minute period. Following a digestion period of 15 minutes, 2.0% alumina, by weight of final pigment, was added over 15 minutes as a 357 gram/liter aqueous sodium aluminate solution while maintaining the pH of the slurry between a value of 8.0 and 8.5 via the concomitant addition of 25% aqueous sulfuric acid.

The dispersion was allowed to equilibrate at 90° C. for 15 minutes, at which point the pH of the slurry was re-adjusted to 5.8, prior to filtration while hot. The resulting filtrate was washed with an amount of water, which had been preheated to 60° C. and pre-adjusted to a pH of 7.0, equal to the weight of recovered pigment. The washed semi-solid filtrate was subsequently re-dispersed in water with agitation in the presence of 1.0%, by weight based on pigment, of 3-chloropropyltrimethoxysilane according to the present invention. The resulting pigment dispersion was spray dried using an APV Nordic PSD52 Spray Dryer, maintaining a dryer inlet temperature of approximately 280° C., to yield a dry pigment powder. The dry pigment powder was then steam micronized in the presence of 0.35% by weight based on pigment of trimethylol propane, utilizing a steam to pigment weight ratio of 2.5, with a steam injector pressure set at 146 psi and micronizer ring pressure set at 118 psi, completing the finished pigment preparation.

As a comparative example, the same procedure described above was repeated, but in the absence of the addition of the chloropropyltrimethoxysilane. The resulting pigment produced according to the inventive process and the comparative pigment were both evaluated for paint film gloss and tint strength performance in a water-borne coating, according to the recipe and test procedures described in Example 1. Results are provided in Table 3.

TABLE 3
Paint Film Properties of Organosilicon Compound-Treated
TiO₂-Containing Water-Borne Paints

| Pigment Sample | Gloss (60°) | Tint Strength |
|---|---|---|
| Example 3 | 67 | 113 |
| Comp. Ex. 3 | 62 | 107 |

The coating composition produced according to the instant invention, comprising a titanium dioxide pigment having deposited thereon an inorganic oxide surface treatment of 3.0% silica and 2.0% alumina, both by weight of the pigment, and an organic surface treatment comprising 1.0% by weight of pigment of chloropropyltrimethoxysilane, further demonstrates improved properties as indicated by the increased gloss and tint strength values for the inventive coating composition versus the comparative example.

### Example 4

Particulate titanium dioxide pigment intermediate obtained from the vapor phase oxidation of titanium tetrachloride and containing 0.6% alumina in its crystalline lattice was dispersed in water in the presence of 0.18% by weight (based on pigment) of sodium hexametaphosphate dispersant, along with a sufficient amount of sodium hydroxide to adjust the pH of the dispersion to a value of 9.5 or greater, to achieve an aqueous dispersion with a solids content of 35% by weight. The resulting titanium dioxide slurry was sand milled, using a zircon sand-to-pigment weight ratio of 4 to 1, until a volume average particle size was achieved wherein more than 90% of the particles were smaller than 0.63 microns, as determined utilizing a Microtrac X100 Particle Size Analyzer. The slurry was heated to 50° C., acidified to a pH of about 5.0 using concentrated sulfuric acid, then treated with 0.25% zirconia, added rapidly as a 200 gram/liter aqueous zirconium orthosulfate solution, over a five minute period. After the addition of the zirconium orthosulfate, the slurry was maintained at 50° C., adjusted to a pH of 8.0 using 20% by weight aqueous sodium hydroxide solution, then treated with 2.8% alumina, added as a 357 gram/liter aqueous sodium aluminate solution over a fifteen minute period. During the addition of the sodium aluminate solution, the pH of the slurry was maintained between a value of 8.0 and 8.5 via the addition of sulfuric acid, prior to an additional 15 minute digestion at 50° C., after the completion of the addition of the sodium aluminate solution. The dispersion was then filtered while hot. The resulting filtrate was washed with an amount of water, which had been preheated to 60° C. and pre-adjusted to a pH of 7.0, equal to the weight of recovered pigment. The washed filtrate was subsequently re-dispersed in water with agitation. A 1.0% aliquot, by weight based on pigment, of chloropropyltrimethoxysilane was added to the resulting titanium dioxide dispersion with mixing, and the resulting pigment dispersion was spray dried using an APV Nordic PSD52 Spray Dryer, maintaining a dryer inlet temperature of approximately 280° C., to yield a dry pigment powder. The dry pigment powder was then steam micronized in the presence of 0.35% by weight based on pigment of trimethylol propane utilizing a steam to pigment weight ratio of five, with a steam injector pressure set at 146 psi and micronizer ring pressure set at 118 psi, completing the finished pigment preparation.

As a comparative example, the same procedure described above was repeated, but in the absence of the addition of the chloropropyltrimethoxysilane. The resulting pigment produced according to the inventive process and the comparative pigment sample were both evaluated in a water-borne coating, according to the recipe and test procedures described in Example 1. Results are provided in Table 4.

TABLE 4
Paint Film Properties of Organosilicon Compound-Treated
TiO₂-Containing Water-Borne Paints

| Pigment Sample | Gloss (60°) | Tint Strength |
|---|---|---|
| Example 4 | 61 | 108 |
| Comp. Ex. 4 | 60 | 106 |

The coating composition produced according to the instant invention, comprising a titanium dioxide pigment having deposited thereon an inorganic oxide surface treatment of 0.25% zirconia and 2.8% alumina, both by weight of the pigment, and an organic surface treatment comprising 1.0% by weight of pigment of chloropropyltrimethoxysilane according to the present invention, further demonstrates improved properties as indicated by the increased gloss and tint strength values for the inventive coating composition versus the comparative example.

### Example 5

Particulate titanium dioxide pigment intermediate obtained from the vapor phase oxidation of titanium tetrachloride and containing 0.6% alumina in its crystalline lattice was dispersed in water in the presence of 0.18% by weight (based on pigment) of sodium hexametaphosphate dispersant, along with a sufficient amount of sodium hydroxide to adjust the pH of the dispersion to a value of 9.5 and greater, to achieve an aqueous dispersion with a solids content of 35% by weight. The resulting titanium dioxide slurry was sand milled, using a zircon sand-to-pigment weight ratio of 4 to 1, until a volume average particle size was achieved wherein more than 90% of the particles were smaller than 0.63 microns, as determined utilizing a Microtrac X100 Particle Size Analyzer. The slurry was heated to 50° C., acidified to a pH of about 5.0 using concentrated sulfuric acid, then treated with 0.25% zirconia, added rapidly as a 200 gram/liter aqueous zirconium orthosulfate solution, over a five minute period. After the addition of the zirconium orthosulfate, the slurry was maintained at 50° C., adjusted to a pH of 8.0 using 20% by weight aqueous sodium hydroxide solution, then treated with 2.8% alumina, added as a 357 gram/liter aqueous sodium aluminate solution over a fifteen minute period. During the addition of the sodium aluminate solution, the pH of the slurry was maintained between a value of 8.0 and 8.5 via the addition of sulfuric acid, prior to an additional 15 minute digestion at 50° C., after the completion of the addition of the sodium aluminate solution. The dispersion was then filtered while hot. The resulting filtrate was washed with an amount of water, which had been preheated to 60° C. and pre-adjusted to a pH of 7.0, equal to the weight of recovered pigment. The washed filtrate was subsequently re-dispersed in water with agitation, in the presence of 0.25% by weight based on pigment, of methanesulfonic acid as a fluidizing agent. A 0.65% aliquot, by weight based on pigment, of hexyltrimethoxysilane was added to the resulting titanium dioxide dispersion with mixing, and the resulting pigment dispersion was spray dried using an APV Nordic PSD52 Spray Dryer, maintaining a dryer inlet temperature of approximately 280° C., to yield a dry pigment powder. The dry pigment powder was then steam micronized in the presence of 0.35% by weight based on pigment of trimethylol propane utilizing a steam to pigment weight ratio of five, with a steam injector pressure set at 146 psi and micronizer ring pressure set at 118 psi, completing the finished pigment preparation.

As a comparative example, the same procedure described above was repeated, but in the absence of the addition of the hexyltrimethoxysilane. The resulting pigment produced according to the inventive process and the comparative pigment sample were both evaluated in a water-borne coating, according to the recipe and test procedures described in Example 1. Results are provided in Table 5.

TABLE 5
Paint Film Properties of Organosilicon Compound-Treated
TiO₂-Containing Water-Borne Paints

| Pigment Sample | Gloss (60°) | Tint Strength |
|---|---|---|
| Example 5 | 67 | 111 |
| Comp. Ex. 5 | 68 | 108 |

The coating composition produced according to the instant invention, comprising a titanium dioxide pigment having deposited thereon an inorganic oxide surface treatment of 0.25% zirconia and 2.8% alumina, both by weight of the pigment, and an organic surface treatment comprising 0.65% by weight of pigment of hexyltrimethoxysilane, further demonstrates improved properties as indicated by the increased tint strength value for the inventive coating composition versus the comparative example.

### Example 6

Particulate titanium dioxide pigment intermediate obtained from the vapor phase oxidation of titanium tetrachloride and containing 0.6% alumina in its crystalline lattice was dispersed in water in the presence of 0.18% by weight (based on pigment) of sodium hexametaphosphate dispersant, along with a sufficient amount of sodium hydroxide to adjust the pH of the dispersion to a value of 9.5 and greater, to achieve an aqueous dispersion with a solids content of 35% by weight. The resulting titanium dioxide slurry was sand milled, using a zircon sand-to-pigment weight ratio of 4 to 1, until a volume average particle size was achieved wherein more than 90% of the particles were smaller than 0.63 microns, as determined utilizing a Microtrac X100 Particle Size Analyzer. The slurry was heated to 50° C., acidified to a pH of about 5.0 using concentrated sulfuric acid, then treated with 0.25% zirconia, added rapidly as a 200 gram/liter aqueous zirconium orthosulfate solution, over a five minute period. After the addition of the zirconium orthosulfate, the slurry was maintained at 50° C., adjusted to a pH of 8.0 using 20% by weight aqueous sodium hydroxide solution, then treated with 2.8% alumina, added as a 357 gram/liter aqueous sodium aluminate solution over a fifteen minute period. During the addition of the sodium aluminate solution, the pH of the slurry was maintained between a value of 8.0 and 8.5 via the addition of sulfuric acid, prior to an additional 15 minute digestion at 50° C., after the completion of the addition of the sodium aluminate solution. The dispersion was then filtered while hot. The resulting filtrate was washed with an amount of water, which had been preheated to 60° C. and pre-adjusted to a pH of 7.0, equal to the weight of recovered pigment. The washed filtrate was subsequently re-dispersed in water with agitation. A 0.65% aliquot, by weight based on pigment, of hexyltrimethoxysilane was added to the resulting titanium dioxide dispersion with mixing, and the resulting pigment dispersion was spray dried using an APV Nordic PSD52 Spray Dryer, maintaining a dryer inlet temperature of approximately 280° C., to yield a dry pigment powder. The dry pigment powder was then steam micronized in the presence of 0.35% by weight based on pigment of trimethylol propane utilizing a steam to pigment weight ratio of five, with a steam injector pressure set at 146 psi and micronizer ring pressure set at 118 psi, completing the finished pigment preparation.

As a comparative example, the same procedure described above was repeated, but in the absence of the addition of the hexyltrimethoxysilane. The resulting pigment produced according to the inventive process and the comparative pigment sample were both evaluated in a water-borne coating, according to the recipe and test procedures described in Example 1. Results are provided in Table 6.

TABLE 6
Paint Film Properties of Organosilicon Compound-Treated
TiO₂-Containing Water-Borne Paints

| Pigment Sample | Gloss (60°) | Tint Strength |
|---|---|---|
| Example 6 | 68 | 104 |
| Comp. Ex. 6 | 60 | 106 |

The coating composition produced according to the instant invention, comprising a titanium dioxide pigment having deposited thereon an inorganic oxide surface treatment of 0.25% zirconia and 2.8% alumina, both by weight of the pigment, and an organic surface treatment comprising 1.0% by weight of pigment of hexyltrimethoxysilane, still further demonstrates improved properties as indicated by the increased gloss value for the inventive coating composition versus the comparative example.

1. An aqueous coating composition, comprising water, a film- forming component and at least one titanium dioxide pigment surface treated with one or more organosilicon compounds from the alkyltrialkoxysilanes, dialkylalkoxysilanes and mixtures, oligomers and copolymers of the alkyltrialkoxysilanes and dialkyldialkoxysilanes, in which the alkyl groups contain from three to six carbon atoms.

2. An aqueous coating composition according to claim 1, wherein the alkyl groups contain an oxygen atom or contain one or both of chlorine and fluorine heteroatoms.

3. An aqueous coating composition according to claim 2, wherein the alkyl groups are those containing three carbon atoms.

4. (canceled)

5. An aqueous coating composition according to claim 1, wherein the one or more organosilicon compounds are present on the titanium dioxide in an amount ranging from about 0.1 to about 5 weight percent in total, based on the weight of the titanium dioxide.

6. An aqueous coating composition according to claim 5, wherein the one or more organosilicon compounds are present on the titanium dioxide in an amount ranging from about 0.25 to about 2.5 weight percent in total, based on the weight of the titanium dioxide.

7. An aqueous coating composition according to claim 6, wherein the one or more organosilicon compounds are present on the titanium dioxide in an amount ranging from about 0.5 to about 1.5 weight percent in total, based on the weight of the titanium dioxide.

8. An aqueous coating composition according to claim 4, wherein the alkyl groups contain an oxygen atom or contain one or both of chlorine and fluorine heteroatoms.
